(19) United States
(12) Patent Application Publication
(10) Pub. No.: US 2006/0185694 A1
(43) Pub. Date: Aug. 24, 2006

(54) Rinsing step in supercritical processing

(76) Inventors: Richard Brown, Gilbert, AZ (US); Joseph Hillman, Scottsdale, AZ (US)

Correspondence Address: HAVERSTOCK & OWENS LLP, 162 NORTH WOLFE ROAD, SUNNYVALE, CA, 94086, US

(21) Appl. No.: 11/065,636

(22) Filed: Feb. 23, 2005

(51) Int. Cl. B08B 7/04; B08B 3/00; B08B 3/12

(52) U.S. Cl. 134/26; 134/94.1; 134/10; 134/184; 134/103.1

(57) ABSTRACT

An apparatus for removing a residue from a surface of an object located on a support region within a processing chamber is disclosed. The apparatus comprises means for performing a dual-pressure rinsing process and means for performing a series of decompression cycles. The means for performing a dual-pressure rinsing process comprises: means for pressurizing the processing chamber to a first pressure; means for introducing a rinsing chemistry into the processing chamber; means for recirculating the rinsing chemistry within the processing chamber for a first period of time; means for increasing a pressure of the processing chamber to a second pressure; and means for recirculating the rinsing chemistry within the processing chamber for a second period of time.

### CROSS-REFERENCE TO RELATED APPLICATIONS

This patent application is related to commonly owned co-pending U.S. patent application Ser. No. (SSI 10800), filed ______, entitled “ETCHING AND CLEANING BPSG MATERIAL USING SUPERCRITICAL PROCESSING” and U.S. patent application Ser. No. (SSI 05901), filed ______, entitled “IMPROVED CLEANING STEP IN SUPERCRITICAL PROCESSING”, which are hereby incorporated by reference in its entirety.

### FIELD OF THE INVENTION

The present invention relates to the field of removing residues and contaminants in the fabrication of semiconductor devices or other objects. More particularly, the present invention relates to the field of rinsing in supercritical processing to remove photoresist residue and other residues and contaminants from semiconductor wafers, substrates, and other media requiring low contamination levels. BACKGROUND OF THE INVENTION

It is well known in the industry that particulate surface contamination of semiconductor wafers typically degrades device performance and affects yield. When processing wafers, it is desirable that particles and contaminants such as but not limited to photoresist, photoresist residue, and residual etching reactants and byproducts be minimized.

Supercritical fluids have been suggested for the cleaning of semiconductor wafers (e.g., an approach to using supercritical carbon dioxide to remove exposed organic photoresist film is disclosed in U.S. Pat. No. 4,944,837 to Nishikawa, et al., entitled “Method of Processing an Article in a Supercritical Atmosphere,” issued Jul. 31, 1990). A fluid enters the supercritical state when it is subjected to a combination of pressure and temperature at which the density of the fluid approaches that of a liquid. Supercritical fluids exhibit properties of both a liquid and a gas. For example, supercritical fluids are characterized by solvating and solubilizing properties that are typically associated with compositions in the liquid state. Supercritical fluids also have a low viscosity that is characteristic of compositions in the gaseous state.

A problem in semiconductor manufacturing is that the cleaning step generally does not completely remove photoresist residue and other residues and contaminants on the surface of the wafer. It would be advantageous after the cleaning step to be able to remove the photoresist residue and contaminants from the surface features on the wafer surface.

What is needed is an effective method of rinsing to remove cleaning residue such as photoresist, photoresist residue, and other residues and contaminants such as residual etching reactants and byproducts from semiconductor wafers, substrates, and other media requiring low contamination levels.

### SUMMARY OF THE INVENTION

In one embodiment of the present invention, a method of removing a residue from a surface of an object located on a support region within a processing chamber comprises the steps of: performing a dual-pressure rinsing process; and performing a series of decompression cycles.

### BRIEF DESCRIPTION OF THE DRAWINGS

A more complete appreciation of various embodiments of the invention and many of the attendant advantages thereof will become readily apparent with reference to the following detailed description, particularly when considered in conjunction with the accompanying drawings, in which:

FIG. 1 shows an exemplary block diagram of a processing system in accordance with an embodiment of the invention;

FIGS. 2A and 2B illustrate exemplary graphs of pressure versus time for supercritical processes in accordance with embodiments of the invention; and

FIG. 3 is a flow chart showing a method of removing a residue in accordance with embodiments of the present invention.

### DETAILED DESCRIPTION OF SEVERAL EMBODIMENTS

The present invention is directed to an apparatus for and methods of rinsing a surface of a substrate after it is subjected to a cleaning process, such as a semiconductor substrate.

The removal of the photoresist, photoresist residue and other residues and contaminants such as residual etching reactants and byproducts is commonly known as stripping. Current stripping techniques may not provide adequate removal of hardened photoresist and/or sidewall deposited resist or residue, or residues and contaminants in difficult crevices or grooves of device structures, particularly when critical dimensions are in the submicron range. For example, wet chemical methods can be rendered ineffective as to grooves and crevices because the solvent access to the resist or residue to be removed is limited by reason of surface tension and capillary actions. Semiconductor manufacturing processes such as surface hardening of photoresist by ultraviolet radiation, reactive ion etching, or ion implantation have a tendency to increase the difficulty in the removal of residue and contaminants using the current stripping methods.

The methods and apparatus in accordance with the present invention utilize the low viscosity and solvating and solubilizing properties of supercritical carbon dioxide to assist in the cleaning and the rinsing process. For purposes of the invention, “carbon dioxide” should be understood to refer to carbon dioxide (CO₂) employed as a fluid in a liquid, gaseous or supercritical (including near supercritical) state. “Supercritical carbon dioxide” refers herein to CO₂ at conditions above the critical temperature (30.5° C.) and critical pressure (7.38 MPa). When CO₂ is subjected to pressures and temperatures above 7.38 MPa and 30.5° C., respectively, it is determined to be in the supercritical state. “Near-supercritical carbon dioxide” refers to CO₂ within about 85% of absolute critical temperature and critical pressure.

It should be appreciated that the liquid, gaseous, or supercritical carbon dioxide can be provided in any combination as a composition. Liquid, gaseous, or supercritical CO₂ compositions preferred for use in the embodiments of the present invention may include CO₂ and a rinsing chemistry. Liquid, gaseous, or supercritical CO₂ compositions preferred for use in the embodiments of the present invention may include CO₂ and a cleaning or rinsing chemistry. The cleaning and/or rinsing chemistry enhances the properties of the supercritical CO₂ to promote association of the amphiphilic species with the contaminant and to remove the contaminant in the chemical-laden supercritical CO₂.

Various objects can be cleaned using the apparatus and methods of the present invention such as substrates. For the purposes of the invention, “object” typically refers to semiconductor wafers, substrates, and other media requiring low contamination levels. As used herein, “substrate” includes a wide variety of structures such as semiconductor device structures typically with a deposited photoresist or residue. A substrate can be a single layer of material, such as a semiconductor wafer, or can include any number of layers. A substrate can comprise various materials, including semiconductors, metals, ceramics, glass, or compositions thereof.

A wide variety of materials can be effectively removed using the methods and apparatus of the invention. For example, photoresist, photoresist residue, carbon-fluorine containing polymers such as photoresist, and those resulting from oxide etching processes or plasma etch processes, and other residues and contaminants such as residual etching reactants and byproducts can be removed according to the present invention. The methods and apparatus of the invention are particularly advantageous for the removal of ultraviolet radiation hardened photoresist, reactive ion etching or ion implantation hardened resist, and residues and contaminants in crevices or grooves of device structures having critical dimensions below 0.25 microns.

In one embodiment of the present invention, an apparatus for removing a residue from a surface of a substrate includes means for performing a dual-pressure rinsing process.

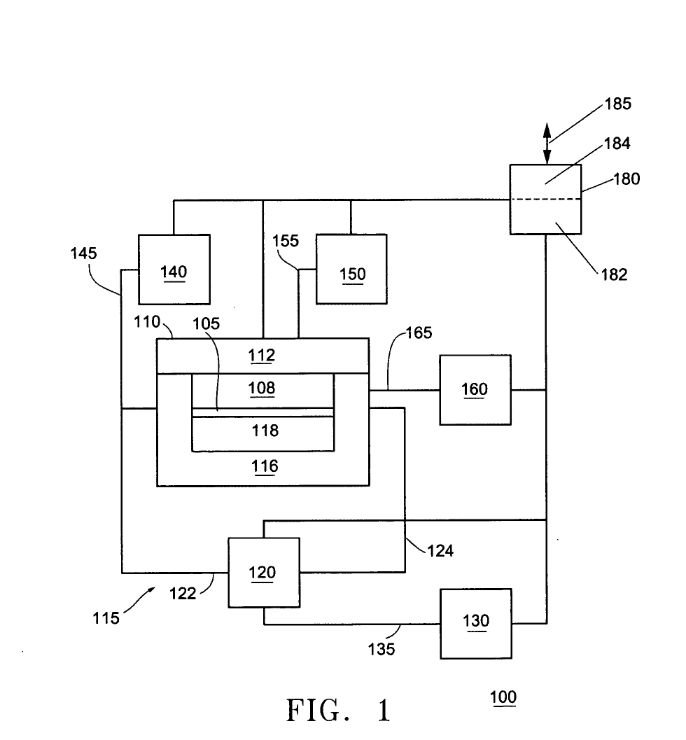

FIG. 1 shows an exemplary block diagram of a processing system in accordance with an embodiment of the invention. In the illustrated embodiment, processing system 100 comprises a process module 110, a recirculation system 120, a process chemistry supply system 130, a high-pressure fluid supply system 140, a pressure control system 150, an exhaust system 160, and a controller 180. The processing system 100 can operate at pressures that can range from 1000 psi. to 10,000 psi. In addition, the processing system 100 can operate at temperatures that can range from 40 to 300 degrees Celsius.

The details concerning one example of a processing chamber are disclosed in co-owned and co-pending U.S. patent application Ser. No. 09/912,844, entitled “HIGH PRESSURE PROCESSING CHAMBER FOR SEMICONDUCTOR SUBSTRATE,” filed Jul. 24, 2001, Ser. No. 09/970,309, entitled “HIGH PRESSURE PROCESSING CHAMBER FOR MULTIPLE SEMICONDUCTOR SUBSTRATES,” filed Oct. 3, 2001, Ser. No. 10/121,791, entitled “HIGH PRESSURE PROCESSING CHAMBER FOR SEMICONDUCTOR SUBSTRATE INCLUDING FLOW ENHANCING FEATURES,” filed Apr. 10, 2002, and Ser. No. 10/364,284, entitled “HIGH-PRESSURE PROCESSING CHAMBER FOR A SEMICONDUCTOR WAFER,” filed Feb. 10, 2003, the contents of which are incorporated herein by reference.

The controller 180 can be coupled to the process module 110, the recirculation system 120, the process chemistry supply system 130, the high-pressure fluid supply system 140, the pressure control system 150, and the exhaust system 160. Alternately, controller 180 can be coupled to one or more additional controllers/computers (not shown), and controller 180 can obtain setup, configuration, and/or recipe information from an additional controller/computer.

In FIG. 1, singular processing elements (110, 120, 130, 140, 150, 160, and 180) are shown, but this is not required for the invention. The semiconductor processing system 100 can comprise any number of processing elements having any number of controllers associated with them in addition to independent processing elements.

The controller 180 can be used to provide setup, configuration, and/or recipe information to any number of processing elements (110, 120, 130, 140, 150, and 160), and the controller 180 can collect, provide, process, store, and display data from processing elements. The controller 180 can comprise a number of applications for controlling one or more of the processing elements. For example, controller 180 can include a GUI component (not shown) that can provide easy to use interfaces that enable a user to monitor and/or control one or more processing elements.

The process module 110 can include an upper assembly 112 and a lower assembly 116, and the upper assembly 112 can be coupled to the lower assembly 116 to configure a processing chamber 108 therewithin. In one embodiment, the process module 110 can include a holder or chuck 118 for supporting and holding the substrate 105 while processing the substrate 105. The holder or chuck 118 can also be configured to heat or cool the substrate 105 before, during, and/or after processing the substrate 105. Alternately, the process module 110 can include a platen for supporting and holding the substrate 105 while processing the substrate 105. In an alternate embodiment, a frame and/or injection ring may be included and may be coupled to an upper assembly and a lower assembly.

The process module 110 can include means for flowing a processing fluid through the processing chamber 108. In one example, a circular flow pattern can be established, and in another example, a substantially linear flow pattern can be established. Alternately, the means for flowing can be configured differently. The lower assembly 116 can comprise one or more lifters (not shown) for moving the chuck 118 and/or the substrate 105. Alternately, a lifter is not required. The upper assembly 112 can comprise a heater (not shown) for heating the process chamber, the substrate, or the processing fluid, or a combination of two or more thereof. Alternately, a heater is not required in the upper assembly 112. In another embodiment, the lower assembly 116 can comprise a heater (not shown) for heating the process chamber, the substrate, or the processing fluid, or a combination of two or more thereof.

A transfer system (not shown) can be used to move a substrate into and out of the processing chamber 108 through a slot (not shown). In one example, the slot can be opened and closed by moving the chuck, and in another example, the slot can be controlled using a gate valve.

The substrate can include semiconductor material, metallic material, dielectric material, ceramic material, or polymer material, or a combination of two or more thereof. The semiconductor material can include Si, Ge, Si/Ge, or GaAs. The metallic material can include Cu, Al, Ni, Pb, Ti, Ta, or W, or combinations of two or more thereof. The dielectric material can include Si, O, N, or C, or combinations of two or more thereof. The ceramic material can include Al, N, Si, C, or O, or combinations of two or more thereof.

In one embodiment, the recirculation system can be coupled to the process module 110 using one or more inlet lines 122 and one or more outlet lines 124, and a recirculation loop 115 can be configured that includes a portion of the recirculation system, a portion of the process module 110, one or more of the inlet lines 122, and one or more of the outlet lines 124. In one embodiment, the recirculation loop 115 comprises a volume of approximately one liter. In alternate embodiments, the volume of the recirculation loop 115 can vary from approximately 0.5 liters to approximately 2.5 liters.

The recirculation system 120 can comprise one or more pumps (not shown); can be used to regulate the flow of the supercritical processing solution through the processing chamber 108 and the other elements in the recirculation loop 115. The flow rate can vary from approximately 0.01 liters/minute to approximately 100 liters/minute.

The recirculation system 120 can comprise one or more valves (not shown) for regulating the flow of a supercritical processing solution through the recirculation loop 115. For example, the recirculation system 120 can comprise any number of back-flow valves, filters, pumps, and/or heaters (not shown) for maintaining a supercritical processing solution and flowing the supercritical process solution through the recirculation system 120 and through the processing chamber 108 in the process module 110.

Processing system 100 can comprise a process chemistry supply system 130. In the illustrated embodiment, the process chemistry supply system is coupled to the recirculation system 120 using one or more lines 135, but this is not required for the invention. In alternate embodiments, the process chemistry supply system can be configured differently and can be coupled to different elements in the processing system.

The process chemistry is introduced by the process chemistry supply system 130 into the fluid introduced by the high-pressure fluid supply system 140 at ratios that vary with the substrate properties, the chemistry being used, and the process being performed in the processing chamber 110. The ratio can vary from approximately 0.001 to approximately 15 percent by volume. For example, when the recirculation loop 115 comprises a volume of about one liter, the process chemistry volumes can range from approximately ten microliters to approximately one hundred fifty milliliters. In alternate embodiments, the volume and/or the ratio may be higher or lower.

The process chemistry supply system 130 can comprise a cleaning chemistry assembly (not shown) for providing cleaning chemistry for generating supercritical cleaning solutions within the processing chamber. The cleaning chemistry can include peroxides and a fluoride source. For example, the peroxides can include hydrogen peroxide, benzoyl peroxide, or any other suitable peroxide, and the fluoride sources can include fluoride salts (such as ammonium fluoride salts), hydrogen fluoride, fluoride adducts (such as organic-ammonium fluoride adducts) and combinations thereof.

Further details of fluoride sources and methods of generating supercritical processing solutions with fluoride sources are described in U.S. patent application Ser. No. 10/44,557, filed May 10, 2003, entitled “TETRA-ORGANIC AMMONIUM FLUORIDE AND HF IN SUPERCRITICAL FLUID FOR PHOTORESIST AND RESIDUE REMOVAL”, and U.S. patent application Ser. No. 10/321,341, filed Dec. 16, 2002, entitled “FLUORIDE IN SUPERCRITICAL FLUID FOR PHOTORESIST POLYMER AND RESIDUE REMOVAL,” both incorporated by reference herein.

In addition, the cleaning chemistry can include chelating agents, complexing agents, oxidants, organic acids, and inorganic acids that can be introduced into supercritical carbon dioxide with one or more carrier solvents, such as N,N-dimethylacetamide (DMAc), gamma-butyrolactone (BLO), dimethyl sulfoxide (DMSO), ethylene carbonate (EC), N-methylpyrrolidone (NMP), dimethylpiperidone, propylene carbonate, and alcohols (such a methanol, ethanol and 1-propanol).

The process chemistry supply system 130 can be configured to introduce N-methyl pyrrolidone (NMP), diglycol amine, hydroxyl amine, di-isopropyl amine, tri-isoprpyl amine, tertiary amines, catechol, ammonium fluoride, ammonium bifluoride, methylacetoacetamide, ozone, propylene glycol monoethyl ether acetate, acetylacetone, dibasic esters, ethyl lactate, CHF₃, BF₃, HF, other fluorine containing chemicals, or any mixture thereof. Other chemicals such as organic solvents may be utilized independently or in conjunction with the above chemicals to remove organic materials. The organic solvents may include, for example, an alcohol, ether, and/or glycol, such as acetone, diacetone alcohol, dimethyl sulfoxide (DMSO), ethylene glycol, methanol, ethanol, propanol, or isopropanol (IPA). For further details, see U.S. Pat. No. 6,306,5,64B1, filed May 27, 1998, entitled “REMOVAL OF RESIST OR RESIDUE FROM SEMICONDUCTORS USING SUPERCRITICAL CARBON DIOXIDE”, and U.S. Pat. No. 6,509,141B2, filed Sep. 3, 1999, entitled “REMOVAL OF PHOTORESIST AND PHOTORESIST RESIDUE FROM SEMICONDUCTORS USING SUPERCRITICAL CARBON DIOXIDE PROCESS”, both incorporated by reference herein.

Moreover, the process chemistry supply system 130 can be configured to introduce a peroxide during a cleaning and/or rinsing process. The peroxide can be introduced with any one of the above process chemistries, or any mixture thereof. The peroxide can include organic peroxides, or inorganic peroxides, or a combination thereof. For example, organic peroxides can include 2-butanone peroxide; 2,4-pentanedione peroxide; peracetic acid; t-butyl hydroperoxide; benzoyl peroxide; or m-chloroperbenzoic acid (mCPBA). Other peroxides can include hydrogen peroxide. Alternatively, the peroxide can include a diacyl peroxide, such as: decanoyl peroxide; lauroyl peroxide; succinic acid peroxide; or benzoyl peroxide; or any combination thereof. Alternatively, the peroxide can include a dialkyl peroxide, such as: dicumyl peroxide; 2,5-di(t-butylperoxy)-2,5-dimethylhexane; t-butyl cumyl peroxide; α,α-bis(t-butylperoxy)diisopropylbenzene mixture of isomers; di(t-amyl) peroxide; di(t-butyl) peroxide; or 2,5-di(t-butylperoxy)-2,5-dimethyl-3-hexyne; or any combination thereof. Alternatively, the peroxide can include a diperoxyketal, such as: 1,1-di(t-butylperoxy)-3,3,5-trimethylcyclohexane; 1,1-di(t-butylperoxy)cyclohexane; 1,1-di(t-amylperoxy)-cyclohexane; n-butyl 4,4-di(t-butylperoxy)valerate; ethyl 3,3-di-(t-amylperoxy)butanoate; t-butyl peroxy-2-ethylhexanoate; or ethyl 3,3-di(t-butylperoxy)butyrate; or any combination thereof. Alternatively, the peroxide can include a hydroperoxide, such as: cumene hydroperoxide; or t-butyl hydroperoxide; or any combination thereof. Alternatively, the peroxide can include a ketone peroxide, such as: methyl ethyl ketone peroxide; or 2,4-pentanedione peroxide; or any combination thereof. Alternatively, the peroxide can include a peroxydicarbonate, such as: di(n-propyl)peroxydicarbonate; di(sec-butyl)peroxydicarbonate; or di(2-ethylhexyl)peroxydicarbonate; or any combination thereof. Alternatively, the peroxide can include a peroxyester, such as: 3-hydroxyl-1,1-dimethylbutyl peroxyneodecanoate; α-cumyl peroxyneodecanoate; t-amyl peroxyneodecanoate; t-butyl peroxyneodecanoate; t-butyl peroxypivalate; 2,5-di(2-ethylhexanoylperoxy)-2,5-dimethylhexane; t-amyl peroxy-2-ethylhexanoate; t-butyl peroxy-2-ethylhexanoate; t-amyl peroxyacetate; t-butyl peroxyacetate; t-butyl peroxybenzoate; OO-(t-amyl) O-(2-ethylhexyl)monoperoxycarbonate; OO-(t-butyl) O-isopropyl monoperoxycarbonate; OO-(t-butyl) O-(2-ethylhexyl) monoperoxycarbonate; polyether poly-t-butylperoxy carbonate; or t-butyl peroxy-3,5,5-trimethylhexanoate; or any combination thereof. Alternatively, the peroxide can include any combination of peroxides listed above.

The process chemistry supply system 130 can comprise a rinsing chemistry assembly (not shown) for providing rinsing chemistry for generating supercritical rinsing solutions within the processing chamber. The rinsing chemistry can include one or more organic solvents including, but not limited to, alcohols and ketones. For example, the rinsing chemistry can comprise solvents, such as N,N-dimethylacetamide (DMAc), gamma-butyrolactone (BLO), dimethyl sulfoxide (DMSO), ethylene carbonate (EC), N-methylpyrrolidone (NMP), dimethylpiperidone, propylene carbonate, and alcohols (such a methanol, ethanol and 2-propanol).

Moreover, the process chemistry supply system 130 can be configured to introduce treating chemistry for curing, cleaning, healing (or restoring the dielectric constant of low-k materials), or sealing, or any combination, as applied to low dielectric constant films (porous or non-porous). The chemistry can include hexamethyidisilazane (HMDS), chlorotrimethylsilane (TMCS), trichloromethylsilane (TCMS), dimethylsilyldiethylamine (DMSDEA), tetramethyldisilazane (TMDS), trimethylsilyldimethylamine (TMSDMA), dimethylsilyldimethylamine (DMSDMA), trimethylsilyldiethylamine (TMSDEA), bistrimethylsilyl urea (BTSU), bis(dimethylamino)methyl silane (B[DMA]MS), bis (dimethylamino)dimethyl silane (B[DMA]DS), HMCTS, dimethylaminopentamethyldisilane (DMAPMDS), dimethylaminodimethyldisilane (DMADMDS), disila-aza-cyclopentane (TDACP), disila-oza-cyclopentane (TDOCP), methyltrimethoxysilane (MTMOS), vinyltrimethoxysilane (VTMOS), or trimethylsilylimidazole (TMSI). Additionally, the chemistry may include N-tert-butyl-1,1-dimethyl-1-(2,3,4,5-tetramethyl-2,4-cyclopentadiene-1-yl)silanamine, 1,3-diphenyl-1,1,3,3-tetramethyidisilazane, or tert-butylchlorodiphenylsilane. For further details, see U.S. patent application Ser. No. 10/682,196, filed Oct. 10, 2003, entitled “METHOD AND SYSTEM FOR TREATING A DIELECTRIC FILM”, and U.S. patent application Ser. No. 10/379,984, filed Mar. 4, 2003, entitled “METHOD OF PASSIVATING LOW DIELECTRIC MATERIALS IN WAFER PROCESSING”, both incorporated by reference herein.

The processing system 100 can comprise a high-pressure fluid supply system 140. As shown in FIG. 1, the high-pressure fluid supply system 140 can be coupled to the recirculation system 120 using one or more lines 145, but this is not required. The inlet line 145 can be equipped with one or more back-flow valves, and/or heaters (not shown) for controlling the fluid flow from the high-pressure fluid supply system 140. In alternate embodiments, high-pressure fluid supply system 140 can be configured differently and coupled differently. For example, the high-pressure fluid supply system 140 can be coupled to the process module 110.

The high-pressure fluid supply system 140 can comprise a carbon dioxide source (not shown) and a plurality of flow control elements (not shown) for generating a supercritical fluid. For example, the carbon dioxide source can include a CO₂ feed system, and the flow control elements can include supply lines, valves, filters, pumps, and heaters. The high-pressure fluid supply system 140 can comprise an inlet valve (not shown) that is configured to open and close to allow or prevent the stream of supercritical carbon dioxide from flowing into the processing chamber 108. For example, controller 180 can be used to determine fluid parameters such as pressure, temperature, process time, and flow rate.

The processing system 100 can also comprise a pressure control system 150. As shown in FIG. 1, the pressure control system 150 can be coupled to the process module 110 using one or more lines 155, but this is not required. Line 155 can be equipped with one or more back-flow valves, pumps, and/or heaters (not shown) for controlling the fluid flow to pressure control system 150. In alternate embodiments, pressure control system 150 can be configured differently and coupled differently. For example, the pressure control system 150 can also include one or more pumps (not shown), and a sealing means (not shown) for sealing the processing chamber. In addition, the pressure control system 150 can comprise means for raising and lowering the substrate and/or the chuck.

Furthermore, the processing system 100 can comprise an exhaust control system 160. As shown in FIG. 1, the exhaust control system 160 can be coupled to the process module 110 using one or more lines 165, but this is not required. Line 165 can be equipped with one or more back-flow valves, and/or heaters (not shown) for controlling the fluid flow to the exhaust control system 160. In alternate embodiments, exhaust control system 160 can be configured differently and coupled differently. The exhaust control system 160 can include an exhaust gas collection vessel (not shown) and can be used to remove contaminants from the processing fluid. Alternately, the exhaust control system 160 can be used to recycle the processing fluid.

In one embodiment, controller 180 can comprise a processor 182 and a memory 184. Memory 184 can be coupled to processor 182, and can be used for storing information and instructions to be executed by processor 182. Alternately, different controller configurations can be used. In addition, controller 180 can comprise a port 185 that can be used to couple processing system 100 to another system (not shown). Furthermore, controller 180 can comprise input and/or output devices (not shown).

In addition, at least one of the processing elements (110, 120, 130, 140, 150, 160, and 180) can comprise a GUI component and/or a database component (not shown). In alternate embodiments, the GUI component and/or the database component are not required.

In addition, one or more of the processing elements (110, 120, 130, 140, 150, 160, and 180) may include memory (not shown) for storing information and instructions to be executed during processing and processors for processing information and/or executing instructions. For example, the memory may be used for storing temporary variables or other intermediate information during the execution of instructions by the various processors in the system. One or more of the processing elements can comprise the means for reading data and/or instructions from a computer readable medium. In addition, one or more of the processing elements can comprise the means for writing data and/or instructions to a computer readable medium.

Memory devices can include at least one computer readable medium or memory for holding computer-executable instructions programmed according to the teachings of the invention and for containing data structures, tables, records, or other data described herein.

The processing system 100 can perform a portion or all of the processing steps of the invention in response to the controller 180 executing one or more sequences of one or more computer-executable instructions contained in a memory. Such instructions may be received by the controller from another computer, a computer readable medium, or a network connection.

Stored on any one or on a combination of computer readable media, the present invention includes software for controlling the processing system 100, for driving a device or devices for implementing the invention, and for enabling the processing system 100 to interact with a human user and/or another system, such as a factory system. Such software may include, but is not limited to, device drivers, operating systems, development tools, and applications software. Such computer readable media further includes the computer program product of the present invention for performing all or a portion (if processing is distributed) of the processing performed in implementing the invention.

The term “computer readable medium” as used herein refers to any medium that participates in providing instructions to a processor for execution and/or that participates in storing information before, during, and/or after executing an instruction. A computer readable medium may take many forms, including but not limited to, non-volatile media, volatile media, and transmission media. The term “computer-executable instruction” as used herein refers to any computer code that is executed by a processor, that provides instructions to a processor for execution and/or that participates in storing information before, during, and/or after executing an instruction.

Controller 180, processor 182, memory 184 and other processors and memory in other system elements as described thus far can, unless indicated otherwise below, be constituted by components known in the art or constructed according to principles known in the art. The computer readable medium and the computer executable instructions can also, unless indicated otherwise below, be constituted by components known in the art or constructed according to principles known in the art.

Some setup, recipe, and/or configuration information can be obtained by the processing system 100 from another system (not shown), such as a factory system. Operational rules can be used to establish a control hierarchy. For example, the processing system 100 can operate independently, or can be controlled to some degree by a higher-level system (not shown). In addition, rules can be used to determine when a process is finished, paused, and/or stopped, and what is done when a process is finished, paused, and/or stopped. In addition, rules can be used to determine when to change a process and how to change the process, and rules can be used to specify the action taken for normal processing and the actions taken on exceptional conditions. Operational rules can be used to determine which processes are monitored and which data is used. For example, rules can be used to determine how to manage the data when a process is changed, paused, and/or stopped. In general, rules allow system and/or tool operation to change based on the dynamic state of the system.

Controller 180 can use pre-process data, process data, and post-process data. For example, pre-process data can be associated with an incoming substrate. This pre-process data can include lot data, batch data, run data, composition data, and history data. The pre-process data can be used to establish an input state for a wafer. Process data can include process parameters. Post processing data can be associated with a processed substrate.

The controller 180 can use the pre-process data to predict, select, or calculate a set of process parameters to use to process the substrate. For example, this predicted set of process parameters can be a first estimate of a process recipe. A process model can provide the relationship between one or more process recipe parameters or set points and one or more process results. A process recipe can include a multi-step process involving a set of process modules. Post-process data can be obtained at some point after the substrate has been processed. For example, post-process data can be obtained after a time delay that can vary from minutes to days. The controller can compute a predicted state for the substrate based on the pre-process data, the process characteristics, and a process model. For example, a rinsing rate model can be used along with a contaminant level to compute a predicted rinsing time. Alternately, a cleaning rate model can be used along with a contaminant level to compute a processing time for a cleaning process.

It will be appreciated that the controller 180 can perform other functions in addition to those discussed here. The controller 180 can monitor variables associated with the other components in the processing system 100 and take actions based on these variables. For example, the controller 180 can process these variables, display these variables and/or results on a GUI screen, determine a fault condition, determine a response to a fault condition, and alert an operator.

In a supercritical cleaning/rinsing process, the desired process result can be a process result that is measurable using an optical measuring device, such as a SEM. For example, the desired process result can be an amount of contaminant in a via or on the surface of a substrate. After one or more cleaning process run, the desired process can be measured.

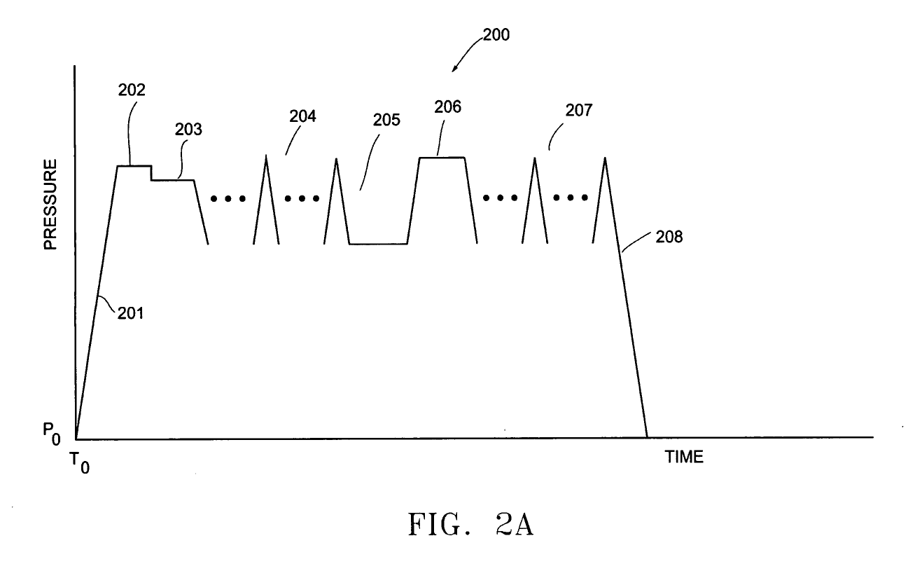

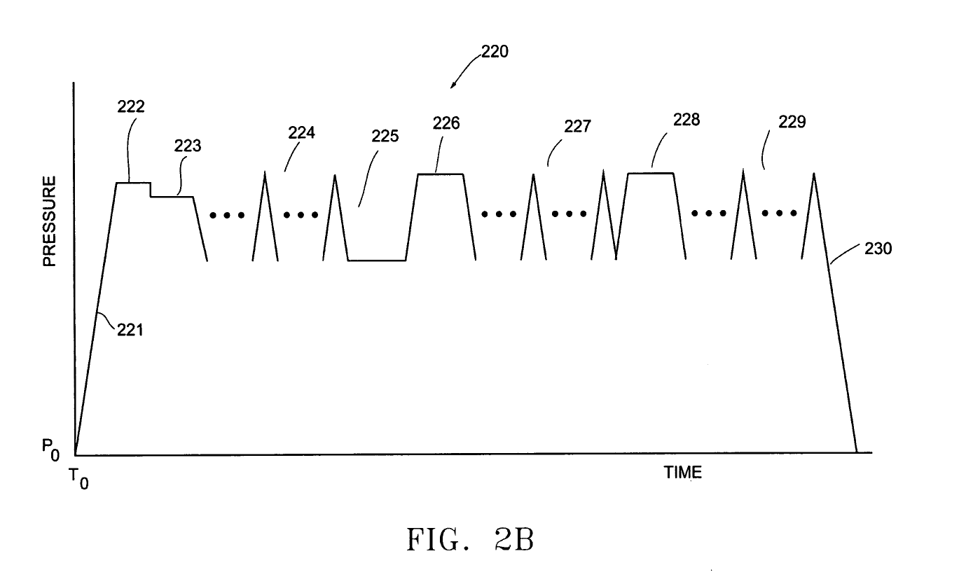

FIG. 2A illustrates an exemplary graph of pressure versus time for a supercritical process step in accordance with an embodiment of the invention. In the illustrated embodiment, a graph 200 of pressure versus time is shown, and the graph 200 can be used to represent a supercritical cleaning process step and a supercritical rinsing process step. Alternately, different pressures, different timing, and different sequences may be used for different processes. In addition, although a single time sequence is illustrated in FIG. 2A, this is not required for the invention. Alternately, multi-sequence processes may be used.

Referring to FIG. 1 and FIG. 2A, prior to an initial time T₀, the substrate to be processed can be placed within the processing chamber 108 and the processing chamber 108 can be sealed. For example, during cleaning and/or rinsing processes, a substrate can have post-etch and/or post-ash residue thereon. The substrate, the processing chamber, and the other elements in the recirculation loop 115 can be heated to an operational temperature. For example, the operational temperature can range from 40 to 300 degrees Celsius.

During time 201, the processing chamber 108 and the other elements in the recirculation loop 115 can be pressurized. For example, a supercritical fluid, such as substantially pure CO₂, can be used to pressurize the processing chamber 108 and the other elements in the recirculation loop 115. During time 201, a pump (not shown) in the recirculation system 120, can be started and can be used to circulate the supercritical fluid through the processing chamber 108 and the other elements in the recirculation loop 115. In an alternate embodiment, process chemistry may be injected during time 201.

During a second time 202, process chemistry can be introduced. In one embodiment, when the pressure in the processing chamber 108 exceeds a critical pressure Pc (1,070 psi), process chemistry can be injected into the processing chamber 108, using the process chemistry supply system 130. For example, the injection(s) of the process chemistries can begin upon reaching about 1100-1200 psi. In alternate embodiments, process chemistry may be injected into the processing chamber 108 before the pressure exceeds the critical pressure Pc (1,070 psi) using the process chemistry supply system 130. In one embodiment, process chemistry is injected in a linear fashion, and the injection time can be based on a recirculation time. For example, the recirculation time can be determined based on the volume/length of the recirculation path and the flow rate. In other embodiments, process chemistry may be injected in a non-linear fashion. For example, process chemistry can be injected in one or more steps.

The process chemistry can include a cleaning agent, a drying agent, or a curing agent, or a combination thereof that is injected into the supercritical fluid. One or more injections of process chemistries can be performed during time 202 to generate a supercritical processing solution with the desired concentrations of chemicals. The process chemistry, in accordance with the embodiments of the invention, can also include one more or more carrier solvents.

During the second time 202, the supercritical processing solution can also be re-circulated over the substrate and through the processing chamber 108 using the recirculation system 120, such as described above. In one embodiment, process chemistry is not injected during the second time 202. Alternatively, process chemistry may be injected into the processing chamber 108 before the second time 202 or after the second time 202.

The processing chamber 108 can operate at a pressure above 1,500 psi during the second time 202. For example, the pressure can range from approximately 2,500 psi to approximately 3,100 psi, but can be any value so long as the operating pressure is sufficient to maintain supercritical conditions. The supercritical conditions within the processing chamber 108 and the other elements in the recirculation loop 115 are maintained during the second time 202, and the supercritical processing solution continues to be circulated over the substrate and through the processing chamber 108 and the other elements in the recirculation loop 115.

In one embodiment, during the second time 202, the pressure can be substantially constant. Alternately, the pressure may have different values during different portions of the second time 202.

Still referring to FIG. 1 and FIG. 2A, during a third time 203, a push-through process can be performed. In an alternate embodiment, a push-through process may not be required after each cleaning step. During the third time 203, a new quantity of supercritical carbon dioxide can be fed into the processing chamber 108 and the other elements in the recirculation loop 115 from the high-pressure fluid supply system 140, and the supercritical cleaning solution along with process residue suspended or dissolved therein can be displaced from the processing chamber 108 and the other elements in the recirculation loop 115 through the exhaust control system 160. In an alternate embodiment, supercritical carbon dioxide can be fed into the recirculation system 120 from the high-pressure fluid supply system 140, and the supercritical cleaning solution along with process residue suspended or dissolved therein can also be displaced from the processing chamber 108 and the other elements in the recirculation loop 115 through the exhaust control system 160.

In the illustrated embodiment shown in FIG. 2A, a single second time 202 is followed by a single third time 203, but this is not required. In alternate embodiments, other time sequences may be used to process a substrate.

During a fourth time 204, a decompression process can be performed. In an alternate embodiment, a decompression process is not required. During a fourth time 204, the processing chamber 108 can be cycled through one or more decompression cycles and one or more compression cycles. The pressure can be cycled between a first pressure and a second pressure one or more times. In alternate embodiments, the first pressure and a second pressure can vary. For example, this can be accomplished by lowering the pressure to below approximately 1,500 psi and raising the pressure to above approximately 2,500 psi. In one embodiment, the pressure can be lowered by venting through the exhaust control system 160. The pressure can be increased by adding high-pressure carbon dioxide. In an alternate embodiment, during a portion of the fourth time 204, a third pressure may be established.

Still referring to FIG. 1 and FIG. 2A, during the fifth time 205 and the sixth time 206, a dual pressure process can be performed. The process chemistry used in the dual pressure process can include a rinsing agent, a cleaning agent, a drying agent, or a curing agent, or a combination thereof that is injected into the supercritical fluid. One or more injections of process chemistries can be performed during the dual pressure process to generate a supercritical processing solution with the desired concentrations of chemicals. The process chemistry, in accordance with the embodiments of the invention, can also include one more or more carrier solvents.

In the illustrated embodiment, a two pressure rinsing process is shown, but this is not required. Alternately, a multi-pressure rinsing process can be performed. In another embodiment, a variable pressure rinsing process can be performed. During a dual pressure rinsing process, the processing chamber 108 can be cycled between a first pressure and a second pressure one or more times. In alternate embodiments, the first pressure and/or a second pressure can vary. In one embodiment, the pressure can be lowered by venting through the exhaust control system 160. For example, this can be accomplished by lowering the pressure to below approximately 1,500 psi and raising the pressure to above approximately 2,500 psi. The pressure can be increased by adding high-pressure carbon dioxide.

In one embodiment, a first rinsing pressure is established during the fifth time 205 using supercritical carbon dioxide. When the pressure in the processing chamber 108 exceeds a critical pressure Pc (1,070 psi), rinsing chemistry can be injected into the processing chamber 108, using the process chemistry supply system 130. For example, the injection(s) of the process chemistries can begin upon reaching about 1100-1200 psi. In alternate embodiments, rinsing chemistry may be injected into the processing chamber 108 before the pressure exceeds the critical pressure Pc (1,070 psi) using the process chemistry supply system 130.

In one embodiment, rinsing chemistry is injected in a linear fashion, and the injection time can be based on a recirculation time. For example, the recirculation time can be determined based on the length of the recirculation path and the flow rate. In other embodiments, rinsing chemistry may be injected in a non-linear fashion. For example, rinsing chemistry can be injected in one or more steps.

The rinsing chemistry can be recirculated through the processing chamber 108 and the other elements in the recirculation loop 115 for a first period of time to dissolve and/or remove a portion of a contaminant and/or residue from a surface of the substrate. When the processing chamber pressure is maintained at approximately the first rinsing pressure, the rinsing chemistry can be partially soluble in the supercritical carbon dioxide. For example, the first rinsing chemistry can comprise a solvent and the solvent can be in a substantially liquid phase at the first rinsing pressure. In an alternate embodiment, the solvent can be in a partially liquid phase. It should be appreciated that “dissolve and/or remove a portion of a contaminant and/or residue from a surface” encompasses to soften or loosen a contaminant and/or residue on a surface as well as remove or partially remove a contaminant and/or residue from a surface. In one embodiment, the first period of time is less than about three minutes. Alternately, the first period of time may vary from approximately ten seconds to approximately ten minutes.

Still referring to FIG. 1 and FIG. 2A, during the sixth time 206, the pressure of the processing chamber can be increased. For example, the pressure of the processing chamber can be increased to at least approximately 2700 psi. The pressure increase causes the solvent and the material dissolved in the solvent to go into a supercritical phase. For example, the rinsing chemistry can be recirculated over the substrate for a second period of time to bring the solvent and the material dissolved in the solvent into a supercritical phase so that it can be removed from the substrate and the processing chamber. Additional contaminants and/or residues can also be removed from a surface of the substrate during this time. Alternately, additional rinsing chemistry and/or supercritical fluid may be provided. In one embodiment, the second period of time is less than about three minutes.

In an alternate embodiment, a push-through process (not shown) may be performed after a dual-pressure rinsing process. During a push-through process, a new quantity of supercritical carbon dioxide can be fed into the processing chamber 108 and the other elements in the recirculation loop 115 from the high-pressure fluid supply system 140, and the supercritical rinsing solution along with process residue suspended or dissolved therein can be displaced from the processing chamber 108 and the other elements in the recirculation loop 115 through the exhaust control system 160.

In the illustrated embodiment shown in FIG. 2A, a single fifth time 205 is followed by a single sixth time 206, but this is not required. In alternate embodiments, other time sequences may be used to process a substrate.

Again referring to FIG. 1 and FIG. 2A, during a seventh time 207, a decompression process can be performed. In an alternate embodiment, a decompression process is not required. During the seventh time 207, the processing chamber 108 can be cycled through one or more decompression cycles and one or more compression cycles. The pressure can be cycled between a first pressure and a second pressure one or more times. In alternate embodiments, the first pressure and a second pressure can vary. For example, this can be accomplished by lowering the pressure to below approximately 1,500 psi and raising the pressure to above approximately 2,500 psi. In one embodiment, the pressure can be lowered by venting through the exhaust control system 160, and the pressure can be increased by adding supercritical carbon dioxide.

During an eighth time 208, the processing chamber 108 can be returned to lower pressure. For example, after the decompression and compression cycles are complete, then the processing chamber can be vented or exhausted to a transfer system pressure. For substrate processing, the chamber pressure can be made substantially equal to the pressure inside of a transfer system (not shown) coupled to the processing chamber. In one embodiment, the substrate can be moved from the processing chamber into the transfer, and moved to a second process apparatus or module to continue processing.

In the illustrated embodiment shown in FIG. 2A, the pressure returns to an initial pressure P₀, but this is not required for the invention. In alternate embodiments, the pressure does not have to return to P₀, and the process sequence can continue with additional time steps such as those shown in time steps 201, 202, 203, 204, 205, 206, 207, and/or 208. In addition, the time steps 201, 202, 203, 204, 205, 206, 207, and/or 208 may vary in length from approximately three seconds to approximately ten minutes.

The graph 200 is provided for exemplary purposes only. It will be understood by those skilled in the art that a supercritical process can have any number steps having different time/pressures or temperature profiles without departing from the scope of the invention. Further, any number of cleaning and rinse processing sequences with each step having any number of compression and decompression cycles are contemplated. In addition, as stated previously, concentrations of various chemicals and species within a supercritical processing solution can be readily tailored for the application at hand and altered at any time within a supercritical processing step.

FIG. 2B illustrates an exemplary graph of pressure versus time for a supercritical process step in accordance with an embodiment of the invention. In the illustrated embodiment, a graph 220 of pressure versus time is shown, and the graph 220 can be used to represent a supercritical process that can include one or more cleaning steps, one or more rinsing steps, and one or more additional processing step. Alternately, different pressures, different timing, and different sequences may be used. In addition, although a single time sequence is illustrated in FIG. 2B, this is not required for the invention. Alternately, multi-sequence processes may be used.

Referring to FIG. 1 and FIG. 2B, prior to an initial time T₀, the substrate to be processed can be placed within the processing chamber 108 and the processing chamber 108 can be sealed. For example, during processes as shown in FIG. 2B, a substrate can have post-etch and/or post-ash residue thereon. The substrate, the processing chamber, and the other elements in the recirculation loop 115 can be heated to an operational temperature. For example, the operational temperature can range from 40 to 300 degrees Celsius.

During time 221, the processing chamber 108 and the other elements in the recirculation loop 115 can be pressurized. For example, a supercritical fluid, such as substantially pure CO₂, can be used to pressurize the processing chamber 108 and the other elements in the recirculation loop 115. During time 221, a pump (not shown) in the recirculation system 120, can be started and can be used to circulate the supercritical fluid through the processing chamber 108 and the other elements in the recirculation loop 115. In an alternate embodiment, process chemistry may be injected during time 221.

During a second time 222, process chemistry can be introduced. In one embodiment, when the pressure in the processing chamber 108 exceeds a critical pressure Pc (1,070 psi), process chemistry can be injected into the processing chamber 108, using the process chemistry supply system 130. For example, the injection(s) of the process chemistries can begin upon reaching about 1100-1200 psi. In alternate embodiments, process chemistry may be injected into the processing chamber 108 before the pressure exceeds the critical pressure Pc (1,070 psi) using the process chemistry supply system 130.

In one embodiment, process chemistry is injected in a linear fashion, and the injection time can be based on a recirculation time. For example, the recirculation time can be determined based on the length of the recirculation path and the flow rate. In other embodiments, process chemistry may be injected in a non-linear fashion. For example, process chemistry can be injected in one or more steps.

The process chemistry can include a cleaning agent, a drying agent, or a curing agent, or a combination thereof that is injected into the supercritical fluid. One or more injections of process chemistries can be performed during time 222 to generate a supercritical processing solution with the desired concentrations of chemicals. The process chemistry, in accordance with the embodiments of the invention, can also include one more or more carrier solvents.

During the second time 222, the supercritical processing solution can also be re-circulated over the substrate and through the processing chamber 108 using the recirculation system 115. In one embodiment, process chemistry is not injected during the second time 222. Alternatively, process chemistry may be injected into the processing chamber 108 before the second time 222 or after the second time 222.

The processing chamber 108 can operate at a pressure above 1,500 psi during the second time 222. For example, the pressure can range from approximately 2,500 psi to approximately 3,100 psi, but can be any value so long as the operating pressure is sufficient to maintain supercritical conditions. The supercritical conditions within the processing chamber 108 and the other elements in the recirculation loop 115 are maintained during the second time 222, and the supercritical processing solution continues to be circulated over the substrate and through the processing chamber 108 and the other elements in the recirculation loop 115. The recirculation system 120 can be used to regulate the flow of the supercritical processing solution through the processing chamber 108 and the other elements in the recirculation loop 115.

In one embodiment, during the second time 222, the pressure can be substantially constant. Alternately, the pressure may have different values during different portions of the second time 222.

Still referring to FIG. 1 and FIG. 2B, during a third time 223, a push-through process can be performed. In an alternate embodiment, a push-through process may not be required after each cleaning step. During the third time 223, a new quantity of supercritical carbon dioxide can be fed into the processing chamber 108 and the other elements in the recirculation loop 115 from the high-pressure fluid supply system 140, and the supercritical cleaning solution along with process residue suspended or dissolved therein can be displaced from the processing chamber 108 and the other elements in the recirculation loop 115 through the exhaust control system 160. In an alternate embodiment, supercritical carbon dioxide can be fed into the recirculation system 120 from the high-pressure fluid supply system 140, and the supercritical cleaning solution along with process residue suspended or dissolved therein can also be displaced from the processing chamber 108 and the other elements in the recirculation loop 115 through the exhaust control system 160.

In the illustrated embodiment shown in FIG. 2B, a single second time 222 is followed by a single third time 223, but this is not required. In alternate embodiments, other time sequences may be used to process a substrate.

Again referring to FIG. 1 and FIG. 2B, during a fourth time 224, a decompression process can be performed. In an alternate embodiment, a decompression process is not required. During the fourth time 224, the processing chamber 108 can be cycled through one or more decompression cycles and one or more compression cycles. The pressure can be cycled between a first pressure and a second pressure one or more times. In alternate embodiments, the first pressure and a second pressure can vary. For example, this can be accomplished by lowering the pressure to below approximately 1,500 psi and raising the pressure to above approximately 2,500 psi. In one embodiment, the pressure can be lowered by venting through the exhaust control system 160. The pressure can be increased by adding high-pressure carbon dioxide.

During the fifth time 225 and the sixth time 226, a dual pressure process can be performed. The process chemistry used in the dual pressure process can include a rinsing agent, a cleaning agent, a drying agent, or a curing agent, or a combination thereof that is injected into the supercritical fluid. One or more injections of process chemistries can be performed during the dual pressure process to generate a supercritical processing solution with the desired concentrations of chemicals. The process chemistry, in accordance with the embodiments of the invention, can also include one more or more carrier solvents.

In the illustrated embodiment, a two pressure rinsing process is shown, but this is not required. Alternately, a multi-pressure rinsing process can be performed. In another embodiment, a variable pressure rinsing process can be performed. During a dual pressure rinsing process, the processing chamber 108 can be cycled between a first pressure and a second pressure one or more times. In alternate embodiments, the first pressure and/or a second pressure can vary. In one embodiment, the pressure can be lowered by venting through the exhaust control system 160. For example, this can be accomplished by lowering the pressure to below approximately 1,500 psi and raising the pressure to above approximately 2,500 psi. The pressure can be increased by adding high-pressure carbon dioxide.

In one embodiment, a first rinsing pressure is established during the fifth time 225 using supercritical carbon dioxide. When the pressure in the processing chamber 108 exceeds a critical pressure Pc (1,070 psi), rinsing chemistry can be injected into the processing chamber 108, using the process chemistry supply system 130. For example, the injection(s) of the process chemistries can begin upon reaching about 1100-1200 psi. In alternate embodiments, rinsing chemistry may be injected into the processing chamber 108 before the pressure exceeds the critical pressure Pc (1,070 psi) using the process chemistry supply system 130.

In one embodiment, rinsing chemistry is injected in a linear fashion, and the injection time can be based on a recirculation time. For example, the recirculation time can be determined based on the length of the recirculation path and the flow rate. In other embodiments, rinsing chemistry may be injected in a non-linear fashion. For example, rinsing chemistry can be injected in one or more steps.

The rinsing chemistry can be recirculated through the processing chamber 108 and the other elements in the recirculation loop 115 for a first period of time to dissolve and/or remove a portion of a contaminant and/or residue from a surface of the substrate. When the processing chamber pressure is maintained at approximately the first rinsing pressure, the rinsing chemistry can be partially soluble in the supercritical carbon dioxide. For example, the first rinsing chemistry can comprise a solvent and the solvent can be in a substantially liquid phase at the first rinsing pressure. In an alternate embodiment, the solvent can be in a partially liquid phase. It should be appreciated that “dissolve and/or remove a portion of a contaminant and/or residue from a surface” encompasses to soften or loosen a contaminant and/or residue on a surface as well as remove or partially remove a contaminant and/or residue from a surface. In one embodiment, the first period of time is less than about three minutes. Alternately, the first period of time may vary from approximately ten seconds to approximately ten minutes.

Still referring to FIG. 1 and FIG. 2B, during the sixth time 226, the pressure of the processing chamber can be increased. For example, the pressure of the processing chamber can be increased to at least approximately 2700 psi. The pressure increase causes the solvent and the material dissolved in the solvent to go into a supercritical phase. For example, the rinsing chemistry can be recirculated over the substrate for a second period of time to bring the solvent and the material dissolved in the solvent into a supercritical phase so that it can be removed from the substrate and the processing chamber. Additional contaminants and/or residues can also be removed from a surface of the substrate during this time. Alternately, additional rinsing chemistry and/or supercritical fluid may be provided. In one embodiment, the second period of time is less than about three minutes.

In an alternate embodiment, a push-through process (not shown) may be performed after a dual-pressure rinsing process. During a push-through process, a new quantity of supercritical carbon dioxide can be fed into the processing chamber 108 and the other elements in the recirculation loop 115 from the high-pressure fluid supply system 140, and the supercritical rinsing solution along with process residue suspended or dissolved therein can be displaced from the processing chamber 108 and the other elements in the recirculation loop 115 through the exhaust control system 160.

In the illustrated embodiment shown in FIG. 2B, a single fifth time 225 is followed by a single sixth time 226, but this is not required. In alternate embodiments, other time sequences may be used to process a substrate.

Again referring to FIG. 1 and FIG. 2B, during a seventh time 227, a decompression process can be performed. In an alternate embodiment, a decompression process is not required. During the seventh time 227, the processing chamber 108 can be cycled through one or more decompression cycles and one or more compression cycles. The pressure can be cycled between a first pressure and a second pressure one or more times. In alternate embodiments, the first pressure and a second pressure can vary. For example, this can be accomplished by lowering the pressure to below approximately 1,500 psi and raising the pressure to above approximately 2,500 psi. In one embodiment, the pressure can be lowered by venting through the exhaust control system 160, and the pressure can be increased by adding supercritical carbon dioxide.

During an eighth time 228, one or more additional processing steps can be performed. In an alternate embodiment, an additional processing step is not required. During the eighth time 228, a drying step, a rinsing step, a cleaning step, a push-through step, or a curing step, or a combination thereof can be performed.

During a ninth time 229, one or more decompression cycles and one or more compression cycles can be performed as described above. In an alternate embodiment, additional decompression cycles and compression cycles may not be required.

During a tenth time 230, the processing chamber 108 can be returned to lower pressure. For example, the processing chamber can be vented or exhausted to a transfer system pressure. For substrate processing, the chamber pressure can be made substantially equal to the pressure inside of a transfer system (not shown) coupled to the processing chamber. In one embodiment, the substrate can be moved from the processing chamber into the transfer system, and moved to a second process apparatus or module to continue processing.

In the illustrated embodiment shown in FIG. 2B, the pressure returns to an initial pressure P₀, but this is not required for the invention. In alternate embodiments, the pressure does not have to return to P₀, and the process sequence can continue with additional time steps such as those shown in time steps 221, 222, 223, 224, 225, 226, 227, 228, 229, and/or 230. In addition, the time steps 221, 222, 223, 224, 225, 226, 227, 228, 229, and/or 230 may vary in length from approximately three seconds to approximately ten minutes.

The graph 220 is provided for exemplary purposes only. It will be understood by those skilled in the art that a supercritical process can have any number steps having different time/pressures or temperature profiles without departing from the scope of the invention. Further, any number of cleaning and rinse processing sequences with each step having any number of compression and decompression cycles are contemplated. In addition, as stated previously, concentrations of various chemicals and species within a supercritical processing solution can be readily tailored for the required application and altered at any time within a supercritical processing step.

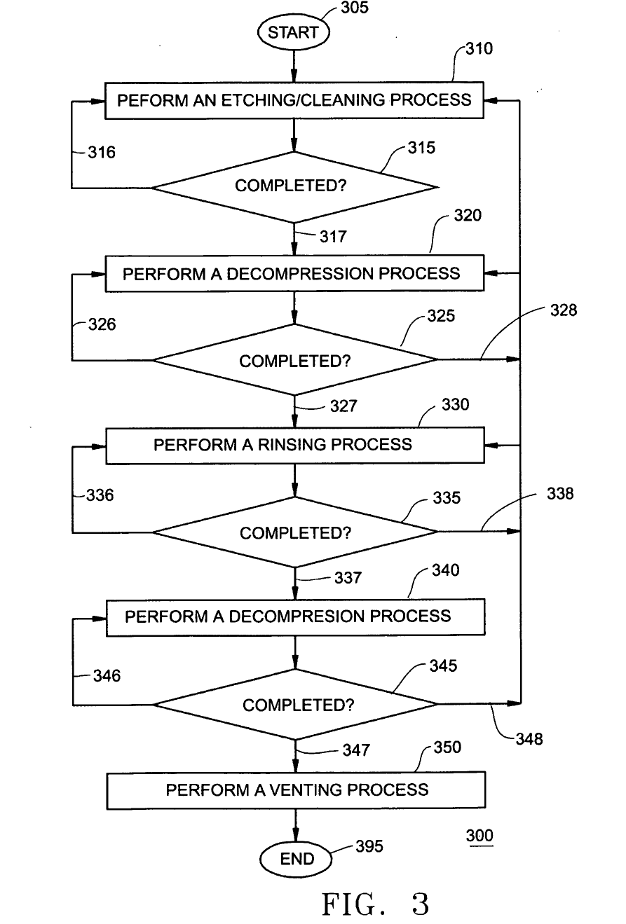

FIG. 3 is a flow chart showing a method of removing a residue from a surface of an object located on a support region within a processing chamber in accordance with embodiments of the present invention. Procedure 300 can start in 305.

Referring to FIG. 1 and FIG. 3, the substrate to be processed can be placed within the processing chamber 108 and the processing chamber 108 can be sealed. For example, during cleaning and/or rinsing processes, a substrate can have post-etch and/or post-ash residue thereon. The substrate, the processing chamber, and the other elements in the recirculation loop 115 can be heated to an operational temperature. For example, the operational temperature can range from 40 to 300 degrees Celsius. In one embodiment, the temperature can be above approximately 100 degrees Celsius. In addition, the processing chamber 108 and the other elements in the recirculation loop 115 can be pressurized. For example, a supercritical fluid, such as substantially pure CO₂, can be used to pressurize the processing chamber 108 and the other elements in the recirculation loop 115. The recirculation system 120 can be used to circulate the supercritical fluid through the processing chamber 108 and the other elements in the recirculation loop 115.

In 310, a cleaning process can be performed. In one embodiment, one or more cleaning agents can be added to the supercritical fluid and a supercritical cleaning process can be performed. Alternately, a non-supercritical cleaning process can be performed. In one embodiment, a cleaning process 310 can include recirculating the cleaning chemistry within the processing chamber 108, and the cleaning chemistry can include DMAc and pyridine-HF. Recirculating the cleaning chemistry over the substrate within the processing chamber can comprise recirculating the cleaning chemistry for a period of time to remove a contaminant from a surface of the substrate.

For example, a process recipe for cleaning can comprise exposing the substrate to a mixture of 15+/−0.5 milliliters of DMAc and 30+/−1 microliters of pyridine-HF in supercritical carbon dioxide for approximately three minutes. Alternate chemistries may include a mixture of 10+/−0.5 milliliters of DMSO and 10+/−0.5 milliliters of BC (butylene carbonate), or a mixture of 20+/−0.5 milliliters of DMAc and 2+/−0.05 milliliters of MeSO₃H (methyl sulfonic acid).

One or more push-through steps can be performed as a part of the cleaning process. During a push-through step, a new quantity of supercritical carbon dioxide can be fed into the processing chamber 108 and the other elements in the recirculation loop 115 from the high-pressure fluid supply system 140, and the supercritical cleaning solution along with process residue suspended or dissolved therein can be displaced from the processing chamber 108 and the other elements in the recirculation loop 115 through the exhaust control system 160. In another embodiment, supercritical carbon dioxide can be fed into the recirculation system 120 from the high-pressure fluid supply system 140, and the supercritical cleaning solution along with process residue suspended or dissolved therein can also be displaced from the processing chamber 108 and the other elements in the recirculation loop 115 through the exhaust control system 160. In an alternate embodiment, a push-through step is not required during a cleaning step.

In 315, a query is performed to determine when the cleaning process has been completed. When the cleaning process is completed, procedure 300 branches to 320 and continues. When the cleaning process is not completed, procedure 300 branches back to 310 and the cleaning process continues. One or more cleaning steps can be performed during a cleaning process. For example, different chemistries, different concentrations, different process conditions, and/or different times can be used in different cleaning steps.

In 320, a decompression process can be performed while maintaining the processing system in a supercritical state. In one embodiment, a two-pressure process can be performed in which the two pressures are above the critical pressure. Alternately, a multi-pressure process can be performed. In another embodiment, a decompression process is not required. During a decompression process, the processing chamber 108 can be cycled through one or more decompression cycles and one or more compression cycles. The pressure can be cycled between a first pressure and a second pressure one or more times. In alternate embodiments, the first pressure and/or a second pressure can vary. In one embodiment, the pressure can be lowered by venting through the exhaust control system 160. For example, this can be accomplished by lowering the pressure to below approximately 1,500 psi and raising the pressure to above approximately 2,500 psi. The pressure can be increased by adding high-pressure carbon dioxide.

In 325, a query is performed to determine when the decompression process 320 has been completed. When the decompression process is completed, procedure 300 can branch 327 to 330, and procedure 300 can continue on to step 330 if no additional cleaning is required. When the decompression process is completed and additional cleaning is required, procedure 300 can branch 328 back to 310, and procedure 300 can continue by performing an additional cleaning process.

When the decompression process is not completed, procedure 300 branches back to 320 and the decompression process continues. One or more pressure cycles can be performed during a decompression process. For example, different chemistries, different concentrations, different process conditions, and/or different times can be used in different pressure steps.

In 330, a dual pressure rinsing process can be performed. In one embodiment, a two pressure rinsing process can be performed. Alternately, a multi-pressure rinsing process can be performed. In another embodiment, a variable pressure rinsing process can be performed. During a dual pressure rinsing process, the processing chamber 108 can be cycled between a first pressure and a second pressure one or more times. In alternate embodiments, the first pressure and/or a second pressure can vary.

In one embodiment, a dual pressure rinsing process can be performed, but this is not required. Alternately, a multi-pressure rinsing process can be performed. In another embodiment, a variable pressure rinsing process can be performed. During a dual pressure rinsing process, the processing chamber 108 can be cycled between a first pressure and a second pressure one or more times. In alternate embodiments, the first pressure and/or a second pressure can vary. In one embodiment, the pressure can be lowered by venting through the exhaust control system 160. For example, this can be accomplished by lowering the pressure to below approximately 1,500 psi and raising the pressure to above approximately 2500 psi. The pressure can be increased by adding high-pressure carbon dioxide.

In one embodiment, a first pressure can be established during the first part of a dual-pressure rinse process using supercritical carbon dioxide. For example, the processing chamber can be pressurized to approximately 1400 psi. In addition, a rinsing chemistry can be introduced into the processing chamber. Then, the rinsing chemistry can be recirculated within the processing chamber for a first period of time to dissolve and/or remove a portion of a contaminant and/or residue from a surface of the substrate. At the first pressure, the rinsing chemistry can be partially soluble in the supercritical carbon dioxide. For example, the first rinsing chemistry can comprise a solvent and the solvent can be in a substantially liquid phase at the first pressure. In an alternate embodiment, the solvent can be in a partially liquid phase. In one embodiment, the first period of time is less than about three minutes. Alternately, the first period of time may vary from approximately ten seconds to approximately ten minutes. During the first period of time, a first rinsing process can be performed that can include recirculating a first rinsing chemistry through the processing chamber, and the first rinsing chemistry can include DMAc.

For example, a process recipe for a first rinsing process can comprise exposing the substrate to a solution of 15+/−0.5 milliliters of DMAc in supercritical carbon dioxide for approximately two minutes. Alternate chemistries may include a mixture of 11+/−0.5 milliliters of a 2:1 mixture of EtOH and H₂O (ethanol and water), or a mixture of (acetone and IPA).

During the next part of a dual-pressure rinse process, the pressure of the processing chamber can be increased. For example, the pressure of the processing chamber can be increased to at least approximately 2700 psi. The pressure increase causes the solvent and the material dissolved in the solvent to go into a supercritical phase. For example, the rinsing chemistry can be recirculated within the processing chamber for a second period of time to bring the solvent and the material dissolved in the solvent into a supercritical phase so that it can be removed from the processing chamber. Additional contaminants and/or residues can also be removed from a surface of the substrate during this time. Alternately, additional rinsing chemistry and/or supercritical fluid may be provided. In one embodiment, the second period of time is less than about three minutes.

During the second period of time, a second rinsing process can be performed that can include recirculating a second rinsing chemistry through the processing chamber, and the second rinsing chemistry can include mixture of EtOH and H₂O.

For example, a process recipe for a second rinsing process can comprise exposing the substrate to a mixture of 11+/−0.5 milliliters of a 2:1 mixture of EtOH and H₂O in supercritical carbon dioxide for approximately two minutes. Alternate chemistries may include a DMAc and acetone and IPA.

In an alternate embodiment, a push-through process (not shown) may be performed after a dual-pressure rinsing process. During a push-through process, a new quantity of supercritical carbon dioxide can be fed into the processing chamber 108 and the other elements in the recirculation loop 115 from the high-pressure fluid supply system 140, and the supercritical rinsing solution along with process residue suspended or dissolved therein can be displaced from the processing chamber 108 and the other elements in the recirculation loop 115 through the exhaust control system 160.

In 335, a query is performed to determine when the dual pressure rinsing process 330 has been completed. When the dual pressure rinsing process is completed, procedure 300 can branch 337 to 340, and procedure 300 can continue on to step 340 if no additional cleaning is required. When the dual pressure rinsing process is completed and additional cleaning is required, procedure 300 can branch 338 back to 310, and procedure 300 can continue by performing an additional cleaning process.

When the dual pressure rinsing process is not completed, procedure 300 can branch 336 back to 330 and the dual pressure rinsing process can continue. One or more rinsing cycles can be performed during a dual pressure rinsing process. For example, different chemistries, different concentrations, different process conditions, and/or different times can be used in different pressure steps.

In 340, a decompression process can be performed. In one embodiment, a two-pressure process can be performed. Alternately, a multi-pressure process can be performed. In another embodiment, decompression process 340 is not required. During a decompression process, the processing chamber 108 can be cycled through one or more decompression cycles and one or more compression cycles. The pressure can be cycled between a first pressure and a second pressure one or more times. In alternate embodiments, the first pressure and/or a second pressure can vary. In one embodiment, the pressure can be lowered by venting through the exhaust control system 160. For example, this can be accomplished by lowering the pressure to below approximately 1,500 psi and raising the pressure to above approximately 2,500 psi. The pressure can be increased by adding high-pressure carbon dioxide.

In 345, a query is performed to determine when the decompression process 340 has been completed. When the decompression process 340 is completed, procedure 300 can branch 347 to 350, and procedure 300 can continue on to step 350 if no additional cleaning or rinsing is required. When the decompression process 340 is completed and additional cleaning is required, procedure 300 can branch 348 back to 310, and procedure 300 can continue by performing an additional cleaning process. When the decompression process 340 is completed and additional rinsing is required, procedure 300 can branch 348 back to 330, and procedure 300 can continue by performing an additional rinsing process.

When the decompression process is not completed, procedure 300 can branch 346 back to 340 and the decompression process continues. One or more pressure cycles can be performed during a decompression process. For example, different chemistries, different concentrations, different process conditions, and/or different times can be used in different pressure steps.

In 350, a venting process can be performed. In one embodiment, a variable pressure venting process can be performed. Alternately, a multi-pressure venting process can be performed. During a venting process, the pressure in the processing chamber 108 can be lowered to a pressure that is compatible with a transfer system pressure. In one embodiment, the pressure can be lowered by venting through the exhaust control system 160.

Procedure 300 ends in 395.

While the invention has been described in terms of specific embodiments incorporating details to facilitate the understanding of the principles of construction and operation of the invention, such reference herein to specific embodiments and details thereof is not intended to limit the scope of the claims appended hereto. It will be apparent to those skilled in the art that modifications may be made in the embodiments chosen for illustration without departing from the spirit and scope of the invention.

What is claimed is:

1. A method of processing a substrate comprising the steps of:
positioning the substrate on a substrate holder in a processing chamber;
pressurizing the processing chamber to a first pressure;
introducing a rinsing chemistry into the processing chamber;
recirculating the rinsing chemistry within the processing chamber for a first period of time to remove a first portion of residue from the substrate;
increasing the processing chamber pressure to a second pressure; and
recirculating the rinsing chemistry within the processing chamber for a second period of time to remove a second portion of residue from the substrate.

2. The method of claim 1, wherein the rinsing chemistry comprises supercritical CO₂ and a first solvent, the first solvent being in a substantially liquid phase at the first pressure.

3. The method of claim 1, further comprising adding a second solvent to the rinsing chemistry when the processing chamber is at the second pressure, wherein the second solvent is in a substantially gaseous phase at the second pressure.

4. The method of claim 1, wherein the rinsing chemistry comprises supercritical CO₂ and a first solvent, the first solvent being partially dissolved in the supercritical CO₂ at the first pressure.

5. The method of claim 1, wherein the rinsing chemistry comprises supercritical CO₂ and a first solvent, the first solvent being substantially totally dissolved in the supercritical CO₂ at the second pressure.

6. The method of claim 1, wherein the substrate comprises a low-k material, an ultra low-k material, or a combination thereof.

7. The method of claim 1, wherein the residue comprises a photoresist residue.

8. The method of claim 1, wherein the first pressure is above approximately 1200 psi and the second pressure is above approximately 2700 psi.

9. The method of claim 1, wherein the step of recirculating the first rinsing chemistry within the processing chamber for a first period of time comprises recirculating the first rinsing chemistry for a first period of time to dissolve the first portion of the residue, wherein a first solvent is in a substantially liquid phase at the first pressure.

10. The method of claim 1, wherein the first period of time is in a range of ten seconds to ten minutes.

11. The method of claim 1, wherein the step of recirculating the rinsing chemistry within the processing chamber for a second period of time, at the second pressure, comprises causing a solvent and the second portion of the residue to move into a supercritical phase with a supercritical CO₂ to remove the second portion of the residue from a surface of the substrate.

12. The method of claim 11, wherein the second period of time is in a range of ten seconds to ten minutes.

13. The method of claim 1, further comprising performing a series of decompression cycles after recirculating the rinsing chemistry within the processing chamber for the second period of time, wherein the processing chamber remains above a supercritical pressure during the series of decompression cycles.

14. The method of claim 13, further comprising the step of performing an additional process after performing the series of decompression cycles.

15. The method of claim 14, wherein the additional process comprises a drying step, a rinsing step, a cleaning step, a push-through step, a decompression cycle, a venting step, or a curing step, or a combination of two or more thereof.

16. The method of claim 1, further comprising the step of performing a cleaning process prior to pressurizing the processing chamber to the first temperature and introducing the cleaning chemistry.

17. The method of claim 16, wherein the cleaning process comprises the steps of:
pressurizing the processing chamber to a first cleaning pressure;
introducing a cleaning chemistry into the processing chamber; and
recirculating the cleaning chemistry within the processing chamber.

18. The method of claim 17, wherein recirculating the cleaning chemistry within the processing chamber comprises recirculating the cleaning chemistry within the processing chamber for a period of time to process a contaminant on a surface of the substrate.

19. The method of claim 1, further comprising the step of pressurizing the processing chamber to push the rinsing chemistry out of the processing chamber after recirculating the rinsing chemistry within the processing chamber for the second period of time.

20. The method of claim 19, wherein pressurizing the processing chamber to push the rinsing chemistry out of the processing chamber comprises pressurizing the processing chamber to above approximately 3000 psi.

21. The method of claim 19, further comprising performing a series of decompression cycles after pushing the rinsing chemistry out of the processing chamber, wherein the processing chamber remains above a supercritical pressure during the series of decompression cycles.

22. The method of claim 21, further comprising the step of performing an additional process after performing the series of decompression cycles.

23. The method of claim 22, wherein the additional process comprises a drying step, a rinsing step, a cleaning step, a push-through step, a decompression cycle, a venting step, or a curing step, or a combination of two or more thereof.

24. An apparatus for removing a residue from a surface of a substrate located on a substrate holder within a processing chamber, comprising:
means for pressurizing the processing chamber to a first pressure using a high-pressure fluid;
means for introducing a rinsing chemistry into the processing chamber, the rinsing chemistry comprising a rinsing agent in the high-pressure fluid;
means for recirculating the rinsing chemistry within the processing chamber for a first period of time to remove a first portion of residue from the substrate, wherein the rinsing agent is partially soluble in the high-pressure fluid during the first period of time;
means for increasing the processing chamber pressure to a second pressure; and
means for recirculating the rinsing chemistry within the processing chamber for a second period of time to remove a second portion of residue from the substrate, wherein the rinsing agent is substantially completely soluble in the high-pressure fluid during the second period of time.

25. The apparatus of claim 24 further comprising:
means for positioning the substrate on the substrate holder in a processing chamber; and
means for removing the substrate from the substrate holder in a processing chamber.

26. The apparatus of claim 24 further comprising:
means for pushing the rinsing chemistry out of the processing chamber after the second period of time.

27. The apparatus of claim 26 further comprising:
means for performing one or more decompression cycles after pushing the rinsing chemistry out of the processing chamber.

28. The apparatus of claim 26 further comprising:
means for performing one or more decompression cycles after the second period of time.

29. A computer-readable medium comprising computer-executable instructions for:
pressurizing a processing chamber to a first pressure using a high-pressure fluid;
introducing a rinsing chemistry into the processing chamber, the rinsing chemistry comprising a rinsing agent in the high-pressure fluid;
recirculating the rinsing chemistry within the processing chamber for a first period of time to remove a first portion of residue from the substrate, wherein the rinsing agent is partially soluble in the high-pressure fluid during the first period of time;
increasing the processing chamber pressure to a second pressure; and
recirculating the rinsing chemistry within the processing chamber for a second period of time to remove a second portion of residue from the substrate, wherein the rinsing agent is substantially completely soluble in the high-pressure fluid during the second period of time.

30. The computer-readable medium of claim 29, further comprising computer-executable instructions for:
positioning a substrate on a substrate holder in a processing chamber; and
removing the substrate from the substrate holder in a processing chamber.

31. The computer-readable medium of claim 29, further comprising computer-executable instructions for:
pushing the rinsing chemistry out of the processing chamber after the second period of time.

32. The computer-readable medium of claim 31, further comprising computer-executable instructions for:
performing one or more decompression cycles after pushing the rinsing chemistry out of the processing chamber.

33. The computer-readable medium of claim 29, further comprising computer-executable instructions for:
means for performing one or more decompression cycles after the second period of time.

34. A method of operating a controller in a processing system configured to process a substrate, the method comprising the steps of:
instructing a high-pressure fluid supply system to pressurize the processing chamber to a first pressure using a high-pressure fluid;
instructing a process chemistry supply system to introduce a rinsing chemistry into the processing chamber, the rinsing chemistry comprising a rinsing agent in the high-pressure fluid;
instructing a recirculation system to recirculate the rinsing chemistry within the processing chamber for a first period of time to remove a first portion of residue from the substrate, wherein the rinsing agent is partially soluble in the high-pressure fluid during the first period of time;
instructing the high-pressure fluid supply system to increase the processing chamber pressure to a second pressure; and
instructing the recirculation system to recirculate the rinsing chemistry within the processing chamber for a second period of time to remove a second portion of residue from the substrate, wherein the rinsing agent is substantially completely soluble in the high-pressure fluid during the second period of time.

35. The method of claim 34, further comprising the steps of:
instructing a transfer system to position a substrate on a substrate holder in a processing chamber before instructing the high-pressure fluid supply system to pressurize the processing chamber.

36. The method of claim 34, further comprising the steps of:
instructing the recirculation system to push the rinsing chemistry out of the processing chamber after the second period of time.

37. The method of claim 36, further comprising the steps of:
instructing the recirculation system to perform one or more decompression cycles after instructing the recirculation system to push the rinsing chemistry out of the processing chamber.

38. The method of claim 34, further comprising the steps of:
instructing the recirculation system to perform one or more decompression cycles after the second period of time.

39. Computer-executable instructions for operating a controller in a processing system configured to process a substrate, the method comprising the steps of:
computer-executable instructions for instructing a high-pressure fluid supply system to pressurize the processing chamber to a first pressure using a high-pressure fluid;
computer-executable instructions for instructing a process chemistry supply system to introduce a rinsing chemistry into the processing chamber, the rinsing chemistry comprising a rinsing agent in the high-pressure fluid;
computer-executable instructions for instructing a recirculation system to recirculate the rinsing chemistry within the processing chamber for a first period of time to remove a first portion of residue from the substrate, wherein the rinsing agent is partially soluble in the high-pressure fluid during the first period of time;
computer-executable instructions for instructing the high-pressure fluid supply system to increase the processing chamber pressure to a second pressure; and
computer-executable instructions for instructing the recirculation system to recirculate the rinsing chemistry within the processing chamber for a second period of time to remove a second portion of residue from the substrate, wherein the rinsing agent is substantially completely soluble in the high-pressure fluid during the second period of time.

40. The computer-executable instructions of claim 39, further comprising:
computer-executable instructions for instructing a transfer system to position a substrate on a substrate holder in a processing chamber before instructing the high-pressure fluid supply system to pressurize the processing chamber.

41. The computer-executable instructions of claim 39, further comprising: computer-executable instructions for instructing the recirculation system to push the rinsing chemistry out of the processing chamber after the second period of time.

42. The computer-executable instructions of claim 41, further comprising: computer-executable instructions for instructing the recirculation system to perform one or more decompression cycles after instructing the recirculation system to push the rinsing chemistry out of the processing chamber.

43. The computer-executable instructions of claim 39, further comprising: computer-executable instructions for instructing the recirculation system to perform one or more decompression cycles after the second period of time.
